(19) United States
(12) Patent Application Publication
(10) Pub. No.: US 2008/0241634 A1
(43) Pub. Date: Oct. 2, 2008

(54) PUMP DRIVING MODULE AND FUEL CELL SYSTEM EQUIPPED WITH THE SAME

(75) Inventors: Jin-hong An, Gyeonggi-do (KR); Hyun Kim, Gyeonggi-do (KR); Ri-a Ju, Suwon-si (KR); Ho-jin Kweon, Suwon-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd, Suwon-si (KR)

(21) Appl. No.: 12/040,817

(22) Filed: Feb. 29, 2008

(30) Foreign Application Priority Data
Mar. 29, 2007 (KR) 10-2007-0030973

(51) Int. Cl. H01M 8/04; F04B 49/06; F04B 43/04

(52) U.S. Cl. 429/34; 417/44.1; 417/413.1

(57) ABSTRACT

A fuel pump driving module used for supplying fuel from a fuel tank to a fuel cell—and more particularly, a driving module for a diaphragm pump, and a fuel cell system equipped with the same—includes a pump controller for generating an ON/OFF signal and a reference pulse to a pump; and a pump driving pulse generation unit for combining the reference pulse according to a predetermined rule to determine a frequency and a duty ratio of the pump driving pulse and activating the pump driving pulse according to the ON/OFF signal to the pump. The pump driving module may be useful to commonly apply a single pump driving module to various manufacturers' fuel pumps, thereby to reduce the fabricating cost of the fuel cell system.

### CROSS-REFERENCE TO RELATED APPLICATION

This application claims the benefit of Korean Patent Application No. 10-2007-0030973, filed on Mar. 29, 2007, in the Korean Intellectual Property Office, the disclosure of which is incorporated herein by reference.

### BACKGROUND

1. Technical Field

The present disclosure relates generally to a fuel pump driving module useful for supplying fuel from a fuel tank to a fuel cell, and more particularly to a driving module for a diaphragm pump, and a fuel cell system equipped with the same.

2. Discussion of Related Art

A fuel cell is a power generation system that generates electrical energy by an electrochemical reaction between hydrogen and oxygen, where the hydrogen is included in a fuel, for example, molecular hydrogen or a hydrocarbon-based material such as methanol, ethanol and natural gas, and the oxygen is present in the air.

Types of fuel cells include phosphate fuel cells, molten carbonate fuel cells, solid-oxide fuel cells, polymer electrolyte membrane fuel cells, alkaline fuel cells, etc., depending on the type of electrolyte used. Each of these types of fuel cells operates on the basic principle, but the fuel, operating temperature, catalyst, electrolyte, etc. of the types of fuel cells are different.

Among these types, the polymer electrolyte membrane fuel cell (PEMFC) has excellent output characteristics, low operating temperature, and rapid starting and response time, compared to the other types of fuel cells, and is widely used in applications such as distributed power source in stationary power plants for housing and public facilities, as well as a transportable power source for portable electronic equipment or as an automobile power source.

A direct methanol fuel cell (DMFC) is similar to the polymer electrolyte membrane fuel cell, but is directly supplied with a liquid methanol fuel to the stack. The direct methanol fuel cell may be miniaturized since it does not use a reformer to produce hydrogen from a fuel, unlike the polymer electrolyte membrane fuel cell.

The above-mentioned direct methanol fuel cell has, for example, a stack, a fuel tank, a fuel pump, and the like. The stack generates electric energy by electrochemically reacting a hydrogen-containing fuel with an oxidizing agent such as oxygen in the air. Such a stack has a laminated structure having several to several tens of unit fuel cells comprising a membrane electrode assembly (MEA) and a separator. Here, the membrane electrode assembly has a structure where the polymer electrolyte membrane is arranged between an anode electrode (so-called, “fuel electrode” or “oxidation electrode”) and a cathode electrode (so-called, “air electrode” or “reduction electrode”), one of which is adhered to each side of the polymer electrolyte membrane.

The pump typically used in the small fuel cell system such as DMFC is a diaphragm pump, and a control module supplied from the pump manufacturer is typically used when the diaphragm pump is actually applied to a fuel cell system.

However, the control modules supplied from different pump manufacturers typically have different input/output signal specifications, and therefore the entire fabrication process of a fuel cell is changed if one manufacturer's pump is substituted with another manufacturer's pump in the mass-production of the fuel cell.

Also, in some cases, even if a control module is supplied from the same pump manufacturer, the corresponding pump does not provide optimum performance. Also, when a pump loses efficiency over long-term use, the manufacturer's pump module generally does not provide a way to optimize the operation of the pump by changing a method for driving a pump.

### SUMMARY OF THE INVENTION

Accordingly, some embodiments are designed to solve such drawbacks, and therefore an object is to provide a pump driving module capable of being generally used with various manufacturers' fuel pumps, and a fuel cell system equipped with the same.

Also, another object is to provide a pump driving module capable of optimizing performances of a pump, and a fuel cell system equipped with the same.

Also, still another object is to provide a pump driving module capable of optimizing the performance of a pump when the performance of the pump degrades with the passage of time, and a fuel cell system equipped with the same.

One embodiment comprises providing a pump driving module including a pump controller for generating an ON/OFF signal and a reference pulse of a pump; and a pump driving pulse generation unit for combining the reference pulse according to a predetermined rule to determine a frequency and a duty ratio of the pump driving pulse and activating the pump driving pulse according to the ON/OFF signal of the pump.

Another embodiment comprises providing a fuel cell system including a fuel cell stack for generating a power through an electrochemical reaction of hydrogen and oxygen; a fuel pump for sucking in a liquid fuel, stored in an external fuel tank, into the inside of the system; a driver controller for controlling the entire operation of the system and generating an ON/OFF signal and a reference pulse for the fuel pump; and a pump driving pulse generation unit for combining the reference pulse according to a predetermined rule to determine a frequency and a duty ratio of the pump driving pulse and activating the pump driving pulse according to the ON/OFF signal of the pump.

Some embodiments provide a pump driving module, comprising: a pump controller configured for generating an ON/OFF signal and a reference pulse for a pump; and a pump driving pulse generation unit configured for combining the reference pulse according to a predetermined rule to determine a frequency and a duty ratio of the pump driving pulse and to activate the pump driving pulse according to the ON/OFF signal to the pump.

In some embodiments, the pump controller further comprises a set value storage unit configured for storing a set value to determine a pattern of the reference pulse.

Some embodiments further comprise an amplitude determination unit configured for determining an amplitude of the pump driving pulse generated by the pump driving pulse generation unit.

In some embodiments, the pump controller comprises: a pump regulator configured for generating the ON/OFF signal to the pump; and a basic pulse generation unit configured for generating a reference pulse according to the set value.

In some embodiments, the pump comprises a diaphragm pump. In some embodiments, the pump comprises a fuel pump configured for pumping a fuel stored in the fuel tank into a fuel cell, and the pump controller comprises a driver controller configured for controlling the entire operation of the fuel cell.

Some embodiments provide a fuel cell system, comprising: a fuel cell stack configured for generating a power through an electrochemical reaction of hydrogen and oxygen; a fuel pump configured for pumping a liquid fuel from an external fuel tank into the system; a driver controller configured for controlling the operation of the system and generating an ON/OFF signal and a reference pulse for the fuel pump; and a pump driving pulse generation unit configured for combining the reference pulse according to a predetermined rule to determine a frequency and a duty ratio of the pump driving pulse and for activating the pump driving pulse according to the ON/OFF signal to the pump.

Some embodiments further comprise a blending apparatus configured for mixing the liquid fuel pumped by the fuel pump with exhaust from the fuel cell stack to generate a diluted fuel, which is later supplied to the fuel cell stack.

Some embodiments further comprise a condenser configured for condensing cathode exhaust from the fuel cell stack and for supplying the condensed cathode exhaust to the blending apparatus.

Some embodiments further comprise a power conversion unit configured for converting the power generated in the fuel cell stack and for supplying the converted power to an external load.

### BRIEF DESCRIPTION OF THE DRAWINGS

These and/or other aspects and advantages will become apparent and more readily appreciated from the following description of the preferred embodiments, taken in conjunction with the accompanying drawings of which:

FIG. 1 is a block view showing an embodiment of a pump driving module.

FIG. 2A is a detailed circuit view showing an embodiment of a pump driving pulse generation unit of the pump driving module as shown in FIG. 1.

FIG. 2B is a waveform view showing an embodiment of a waveform of the pump driving pulse that is determined according to the first reference pulse as shown in FIG. 2A.

FIG. 3 is a block view showing an embodiment of a fuel cell system equipped with the pump driving module.

### DETAILED DESCRIPTION OF CERTAIN EMBODIMENTS

Hereinafter, certain embodiments will be described with reference to the accompanying drawings. Here, when a first element is connected to a second element, the first element may be not only directly connected to the second element but also indirectly connected to the second element via one or more additional elements. Further, elements not needed for understanding are omitted for clarity. Also, like reference numerals refer to like elements throughout.

The term “fuel cell stack” is used for convenience, and includes any suitable stack known in the art, including a stack comprising laminated unit cells, a stack comprising flat unit cells, and a unit stack including single unit cells.

Also, the DMFC fuel cell described below comprises a blending apparatus for recovering and re-using unreacted fuel from the fuel cell stack. Those skilled in the art will understand that the recovery unit is not essential and that the disclosure includes fuel systems that directly supply fuel from a fuel cartridge to a fuel cell stack, or a system using a hydrogen-storing alloy solution, or to other liquid fuels such as acetic acid.

Also, the control module described below is for a fuel pump that draws fuel from the fuel tank. Those skilled in the art will understand that the control module may also be applied to other types of pumps such as a feed pump for supplying fuel to an anode of the fuel cell stack.

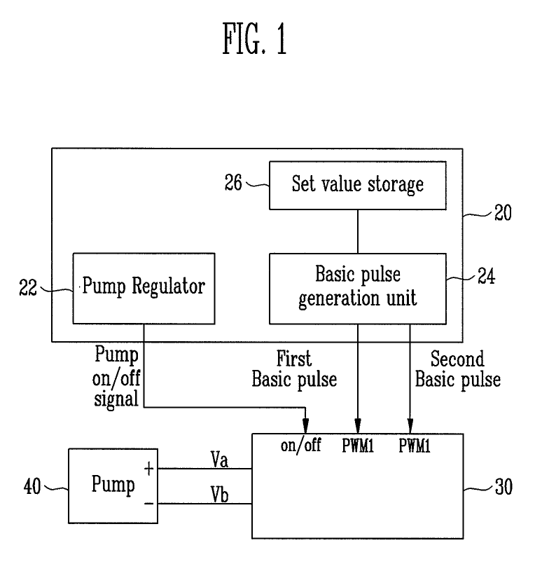

An embodiment of a pump driving module shown in FIG. 1 includes a pump regulator 22 configured for generating an ON/OFF signal for driving a pump 40; a reference or basic pulse generation unit 24 configured for generating a first reference pulse and a second reference pulse; a set value storage unit 26 configured for storing a set value to determine patterns of the first reference pulse and the second reference pulse; a pump driving pulse generation unit 30 configured for combining the first reference pulse and the second reference pulse according to a predetermined rule to determine a frequency and a duty ratio of the pump driving pulse, and configured for activating the pump driving pulse according to the ON/OFF signals of the pump.

The pump regulator 22, the reference pulse generation unit 24 and the set value storage unit 26 may be generally implemented as a single hardware device or module such as a microcontroller in the form of a pump controller 20. Also, the system controller hardware for controlling the entire operation of a fuel cell system may be also implemented within the pump controller 20.

The pump regulator 22 may be a module controlling the entire operation of the fuel cell system, and may be a system controller itself controlling the entire operation of the fuel cell system.

For example, if the pump regulator 22 is implemented as hardware operation equipment, for example, a microcontroller, and software (SW) including a system controller, then the reference pulse generation unit 24 may be realized with a SW module that is run in the operation equipment to generate a reference pulse. For this purpose, the operation equipment should have a terminal for outputting two reference pulses into the outside.

The reference pulse generation unit 24 generates a first reference pulse and a second reference pulse according to a set value. The set value may be represented by a frequency and a duty ratio of the pump driving pulse generated in the pump driving pulse generation unit 30, and represented by parameter, for example, each of a frequency and a phase difference, of the first reference pulse and the second reference pulse. Some embodiments use the frequency and phase difference.

In the case of a diaphragm pump, a frequency of the pump driving pulse should be determined according to the flow rate per unit time, for example, per hour, required by the fuel cell system, and the value of the determined frequency is stored in the set value storage unit 26.

If the pump is not in wide use, then the first reference pulse and the second reference pulse may output a pulse having a fixed parameter, and, in this case, the set value storage unit 26 may be omitted.

The set value storage unit 26 may comprise separate storage hardware, but is preferably a register reserved within the microcontroller, or a code value stored in non-volatile memory.

The pump driving pulse generation unit 30 combines the first reference pulse and the second reference pulse to generate a pump driving pulse. It is preferred to use separate hardware for the pump driving pulse generation unit 30 since the pump driving pulse outputs a certain level of voltage and electric current. Accordingly, although the first reference pulse and the second reference pulse may have poor waveform accuracies and a low signal intensities, the pump driving pulse outputted by the pump driving pulse generation unit 30 is sufficient to drive a pump.

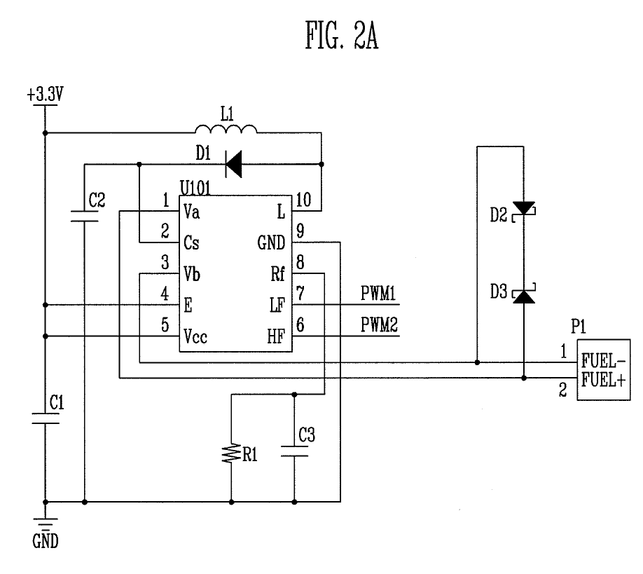

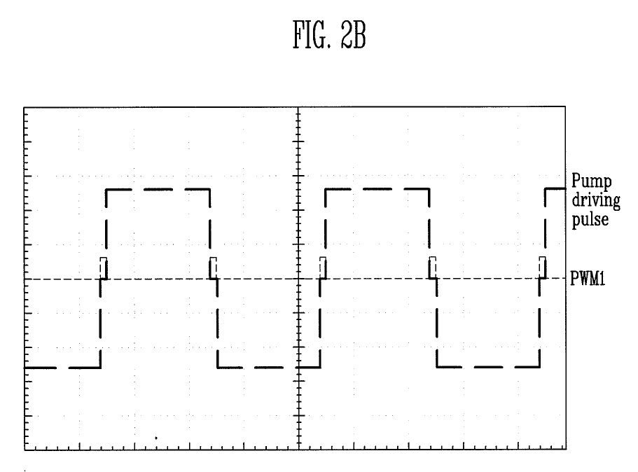

FIG. 2A is a circuit view showing a configuration of the pump driving pulse generation unit 30 comprising control chips. As shown in FIG. 2A, in the illustrated embodiment, the pump driving pulse generation unit 30 is realized using a control chip U101, and therefore the first reference pulse is the input for pin No. 7 of the chip, the second reference pulse is the input for pin No. 6 of the chip, and an ON/OFF signal for driving a pump is inputted into a pin No. 4 of the chip. Those skilled in the art will understand that other control chips or devices are used in other embodiments.

The U101 chip receives the first reference pulse and the second reference pulse and determines a frequency and a duty ratio of the pump driving pulse outputted from the pins No. 1 and 3 according to the phase difference and the frequency of the first reference pulse and the second reference pulse, as particularly shown in FIG. 2B.

As shown in FIG. 2B, the pump driving pulse is transitioned when a first reference pulse (PWM1) is “high”, and therefore the duty ratio of the pump driving pulse may be controlled by forming the first reference pulse at two different distances, and the frequency of the pump driving pulse may be controlled by controlling a frequency of the first reference pulse. The frequency of the pump driving pulse as shown in FIG. 2B has a half value of the frequency of the first reference pulse.

As shown in FIG. 2B, the pump driving pulse may be also realized so that the pump driving pulse has a symmetric shape in the center of Level 0, but have a shape where the lowest level of the pump driving pulse is 0 depending on the type of pump used.

Meanwhile, in the case of the U101 chip used to realize this embodiment, a second reference pulse (PWM2) has a frequency within a range provided in a data book of the corresponding chip.

Returning to FIG. 2A, three capacitors (C1, C2, C3) connected in the manner as shown serve to stabilize the driving of the U101 chip.

The duty ratio of the pump driving pulse is determined according to the kind of pump. It is sufficient to set a duty ratio of the conventional diaphragm pump to 1:1. If the minimum length of a high period or a low period is determined according to the kind of pump, the duty ratio may be set to match the conditions. For example, the minimum length of a desired period may be obtained by changing a duty ratio to 1:1 if the pump driving pulse has a high frequency.

Accordingly, various pumps such as a step motor pump and a DC motor pump as well as a diaphragm pump may be driven.

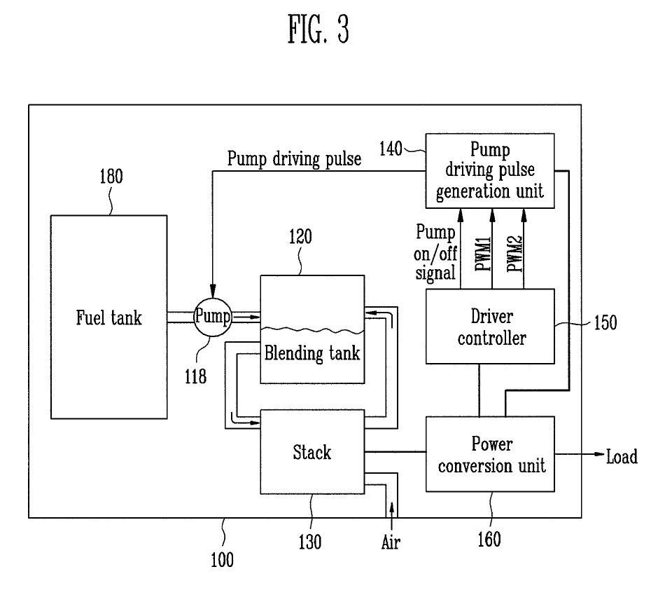

FIG. 3 shows an embodiment of a direct methanol fuel cell system 100 including a pump driving module. The fuel cell system as shown in FIG. 3 includes a fuel cell stack 130 configured for generating electric power through an electrochemical reaction of hydrogen and oxygen; a fuel pump 118 configured for pumping a liquid fuel, stored in a fuel tank 180, into the system; a pump driving controller 150 configured for controlling the entire operation of the system and generating an ON/OFF signal, a first reference pulse and a second reference pulse for the fuel pump 118; a pump driving pulse generation unit 140 configured for combining the first pulse and the second pulse according to a predetermined rule to determine a frequency and a duty ratio of the pump driving pulse and activating the pump driving pulse according to the ON/OFF signal of the pump; and a blending apparatus 120, for example, a blending tank, configured for mixing a liquid fuel pumped by the fuel pump 118 with exhaust from the fuel cell stack 130 to generate a diluted fuel, which is later supplied to the fuel cell stack 130.

According to the illustrated embodiment, the fuel cell system may further include an amplitude determination unit (not shown) configured for determining an amplitude of the pump driving pulse generated by the pump driving pulse generation unit. The amplitude determination unit may be an output buffer coupled to the output stage of the pump driving pulse generation unit. Furthermore, the fuel cell system may further include a condenser (not shown) configured for condensing cathode exhaust of the fuel cell stack 130 and supplying the condensed cathode exhaust to the blending apparatus 120, and also further include a power conversion unit (not shown) comprising a DC-to-DC converter or a DO-to-AC converter configured for converting electric power generated in the fuel cell stack 120 and supplying the converted electric power to an external load.

Also, the fuel cell system may further include a feed pump (not shown) configured for supplying a diluted fuel in the blending apparatus 120 to an anode of the fuel cell stack 130; and an air pump (not shown) configured for providing air to a cathode. The pump driving controller 150 may be realized in part as a system controller for controlling operations of the fuel pump 118 and/or the feed pump, the condenser and the air pump according to the power generation of the fuel cell system.

If a fuel is an aqueous methanol solution, the reaction in the fuel cell stack 130 is represented by the following Scheme 1.

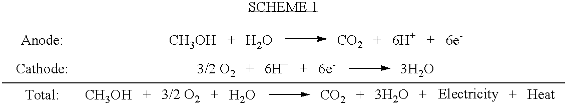

Referring to Scheme 1, a methanol aqueous solution is converted into CO₂, electrons, and hydrogen ions in a catalyst layer at the anode electrode of the membrane electrode assembly (MEA) in the fuel cell stack 130. The hydrogen ions migrate through an electrolyte membrane of the MEA to the cathode, where they react with oxygen, and electrons from an external circuit to generate water. And, anode exhaust (unreacted fuel, carbon dioxide, etc.) and cathode exhaust (water, air, etc.) are exhausted from the anode and the cathode, respectively. According to the procedure, electricity passes through an external circuit, and heat is additionally generated by the chemical reaction the fuel and oxygen.

A high-concentration aqueous methanol solution is stored in the fuel tank 180. The blending apparatus 120 mixes a high-concentration fuel received from the fuel tank 180 with the cathode exhaust from the fuel cell stack 130 to prepare a diluted methanol aqueous solution having a suitable concentration, which is later supplied to the anode of the fuel cell stack 130. Generally, the anode exhaust, as well as the cathode exhaust of fuel cell stack 130, are used in the mixing process.

The fuel pump 118 serves to supply a fuel stored in the fuel tank 180 to the blending apparatus 120, and generally comprises a diaphragm pump in the small portable fuel cell system.

The system controller also functions as the pump driving controller 150 in the illustrated embodiment, and is substantially identical to a typical system controller, except that the system controller also generates a first reference pulse (PWM1) and a second reference pulse (PWM) for the pump driving pulse generation unit. The pump driving controller 150 and the pump driving pulse generation unit 140 may be realized with the configuration as shown in FIG. 1, and, in particular, the pump driving pulse generation unit 140 may be realized with a circuit as shown in FIG. 2.

The fuel pump 118 may be stably driven according to the stabilized pump driving pulse generated in the pump driving pulse generation unit 140. The fuel cell system equipped with the pump driving module according to the embodiment may be used to optimize the performance of the pump. Also, the pump driving module according may be useful to commonly apply a single pump driving module to various manufacturers' fuel pumps, thereby to reduce the fabricating cost of the fuel cell system.

The description proposed herein is just a preferable example for the purpose of illustration only, not intended to limit the scope of the disclosure, which should be understood to include equivalents and modifications as apparent to those skilled in the art. Therefore, it should be understood that the scope of the disclosure is defined in the claims and their equivalents.

What is claimed is:

1. A pump driving module, comprising:
a pump controller configured for generating an ON/OFF signal and a reference pulse for a pump; and
a pump driving pulse generation unit configured for combining the reference pulse according to a predetermined rule to determine a frequency and a duty ratio of the pump driving pulse and to activate the pump driving pulse according to the ON/OFF signal to the pump.

2. The pump driving module according to claim 1, wherein the pump controller further comprises a set value storage unit configured for storing a set value to determine a pattern of the reference pulse.

3. The pump driving module according to claim 1, further comprising an amplitude determination unit configured for determining an amplitude of the pump driving pulse generated by the pump driving pulse generation unit.

4. The pump driving module according to claim 2, wherein the pump controller comprises:
a pump regulator configured for generating the ON/OFF signal to the pump; and
a basic pulse generation unit configured for generating a reference pulse according to the set value.

5. The pump driving module according to claim 1, wherein the pump comprises a diaphragm pump.

6. The pump driving module according to claim 1, wherein the pump comprises a fuel pump configured for pumping a fuel stored in the fuel tank into a fuel cell, and the pump controller comprises a driver controller configured for controlling the entire operation of the fuel cell.

7. A fuel cell system, comprising:
a fuel cell stack configured for generating a power through an electrochemical reaction of hydrogen and oxygen;
a fuel pump configured for pumping a liquid fuel from an external fuel tank into the system;
a driver controller configured for controlling the operation of the system and generating an ON/OFF signal and a reference pulse for the fuel pump; and
a pump driving pulse generation unit configured for combining the reference pulse according to a predetermined rule to determine a frequency and a duty ratio of the pump driving pulse and for activating the pump driving pulse according to the ON/OFF signal to the pump.

8. The fuel cell system according to claim 7, further comprising a blending apparatus configured for mixing the liquid fuel pumped by the fuel pump with exhaust from the fuel cell stack to generate a diluted fuel, which is later supplied to the fuel cell stack.

9. The fuel cell system according to claim 8, further comprising a condenser configured for condensing cathode exhaust from the fuel cell stack and for supplying the condensed cathode exhaust to the blending apparatus.

10. The fuel cell system according to claim 7, further comprising a power conversion unit configured for converting the power generated in the fuel cell stack and for supplying the converted power to an external load.
